(19) United States
(12) Patent Application Publication
(10) Pub. No.: US 2022/0287499 A1
(43) Pub. Date: Sep. 15, 2022

(54) MULTI-FUNCTIONAL SLOW COOKER WITH TEMPERATURE CONTROL FEATURES

(71) Applicant: Spectrum Brands, Inc., Middleton, WI (US)

(72) Inventors: Sean P. Holinka, Madison, WI (US); Benjamin M. Cleppe, Verona, WI (US); Jacob D. Smith, Monona, WI (US); Drew W. Heidenreich, Monona, WI (US); Noah C. Pulvermacher, Madison, WI (US)

(21) Appl. No.: 17/635,061

(22) PCT Filed: Aug. 20, 2020
(86) PCT No.: PCT/US2020/047225

§ 371 Date: Feb. 14, 2022

Related U.S. Application Data
(60) Provisional application No. 62/889,759, filed on Aug. 21, 2019.

(51) Int. Cl. A47J 36/32; A47J 27/00; A47J 36/06; A47J 27/10; H05B 1/02

(52) U.S. Cl. CPC A47J 36/32; A47J 27/004; A47J 36/06; A47J 27/10; H05B 1/0261; A47J 2202/00

(57) ABSTRACT

Slow cookers are described that have multiple cooking modes that are based on user selected choices, including the cooking mode and the desired doneness or temperature of the food product to be cooked. Preferably, plural cooking modes are provided to be selected that include the use of a temperature probe to provided temperature feedback information. A control module can be mounted to the slow cooking and programmed to control the multiple cooking modes and the temperature probe can be operatively connected to the control module to provide sensed temperature data for use in the various cooking modes. Preferably, the cooking modes using the temperature probe include the heating of a cooking vessel within the slow cooker for heating the food product or a liquid within the cooking vessel to a desired temperature and to permit the user greater flexibility in cooking options and to vary option at time during the cooking processes. Moreover, the cooking modes preferably also provide functionality to control the cooking processes after a selected temperature is attained.

### PRIORITY CLAIM

This application claims the benefit of U.S. Provisional Patent Application Ser. No. 62/889,759, filed Aug. 21, 2019, the disclosure of which is incorporated in its entirety herein by reference.

### FIELD OF THE PRESENT INVENTION

The present application relates to cooking appliances that can cook in a variety of cooking modes and settings, and more particularly to a slow cooker including one or more cooking modes that utilize temperature feedback from food product being cooked or liquid within which the food product is submerged.

### BACKGROUND

Cooking appliances come in various configurations and types, and can be powered by electricity in domestic or commercial settings. Some types of cooking appliances include slow cookers, roasters, fryers, grills, steamers, and the like. Some cooking appliances, such as multi-cookers, can provide functionality of one or more cooking appliance types in a single appliance, and can incorporate heating control functionality that permits specialized cooking aspects. In some cases, accessories and/or parts are exchanged while using a multi-purpose heating unit, power unit, and/or control unit

Temperature feedback from a probe can help a controller cook a food product, such as a protein or meat product, by comparing a desired cook temperature of the food product with the actual temperature of the food product up until the desired temperature is achieved. Moreover, controllers can comprise cooking mode instructions, such as saved in memory along with a microprocessor, that control power to one or more heating elements in order to get the food up to the desired temperature and/or to control the time period of the cooking with either a set temperature, such as low, medium, or high. Slow cookers typically control heat at one of three settings for a desired cooking period. Controllers have been developed so that a slow cooker may revert to a low or warm mode after a desired cooking period at a selected temperature has been attained.

### SUMMARY

The present invention is directed to slow cookers that have multiple cooking modes that are based on user selected choices, including the cooking mode and the desired doneness or temperature of the food product to be cooked. Preferably, plural cooking modes are provided to be selected that include the use of a temperature probe to provided temperature feedback information. A control module can be mounted to the slow cooking and programmed to control the multiple cooking modes and the temperature probe can be operatively connected to the control module to provide sensed temperature data for use in the various cooking modes. Preferably, the cooking modes using the temperature probe include the heating of a cooking vessel within the slow cooker for heating the food product or a liquid within the cooking vessel to a desired temperature and to permit the user greater flexibility in cooking options and to vary option at time during the cooking processes. Moreover, the cooking modes preferably also provide functionality to control the cooking processes after a selected temperature is attained.

In one aspect of the present invention, a slow cooker is provided for heating food over time, the slow cooker including a cooking body defining an internal cavity within which a heating element is provided for heating the internal cavity, a cooking vessel removably received within the internal cavity of the heating body, the cooking vessel being heated by the heating element within the internal cavity so that food when positioned within the cooking vessel can also be heated over time, a temperature probe comprising a temperature sensor for reading a sensed temperature of a food product or liquid within the cooking vessel and for communicating the sensed temperature to the control module; and a control module operatively connected with the temperature probe, the control module provided to the cooking body and operatively connected with the heating element for controlling a heat setting of the heating element for cooking food according to one of a plurality of different cooking modes, the control module including a user interface allowing selection from the plural different cooking modes including at least a temperature probe mode, which temperature probe mode controls heating of the food product or liquid within the cooking vessel by the heating element to attain a user selected temperature and to maintain the food product or liquid within the cooking vessel at the user selected temperature for a further time period unless the cooking mode is stopped by a user.

Preferably, the slow cooker includes a lid for closing the cooking vessel that provides plural probe openings through the lid to allow the temperature probe to be inserted within food or liquid within the cooking vessel from plural different angles. The lid can also have a handle the is centrally located and one of the openings is provided through a portion of the handle to accommodate the temperature probe. The probe can have an extension element with the temperature sensor provided near a distal end thereof and the length of the extension element can be determined for positioning the temperature sensor near a bottom of the cooking vessel when the temperature probe is inserted through the opening through the handle portion.

The control module of the slow cooker preferably comprises a microprocessor and memory with programming for controlling the plural cooking modes, wherein the temperature probe mode switches to a time mode after the user selected temperature is attained during which the user selected temperature of the food product will be maintained, the time mode including the starting of a timer provided within a display of the control module counting upward to provide an indication to the user of the time mode timing. The time mode can have a maximum time period, the expiration of which shuts off the slow cooker. Moreover, during the time mode, a user can preferably also manually change the user selected temperature higher or lower. Alternatively, the temperature probe mode can include the ability for the user to provide a user selected time in addition to the user selected temperature at the onset with the user selected time applying to the time period over which the user selected temperature is maintained after the user selected temperature is attained.

Additionally, the control module preferably includes programming for controlling a sous vide mode and a slow cook mode in addition to the temperature probe mode. For the sous vide mode, the heating element is controlled to heat the cooking vessel so as to maintain a liquid within the cooking vessel at a user selected temperature based on sensed temperature feedback from the temperature probe to the control module and to maintain the user selected temperature for a user selected sous vide time period. At the start of the user selected sous vide period a timer provided within a display of the control module will preferably display the user selected sous vide period and begin counting down to provide an indication to the user of the sous vide period remaining. Preferably also, the user selected sous vide time period can be modified at any time during the sous vide cooking mode.

In another aspect of the present invention, a slow cooker is provided for heating food over time, the slow cooker including a cooking body defining an internal cavity within which a heating element is provided for heating the internal cavity, a cooking vessel removably received within the internal cavity of the heating body, the cooking vessel being heated by the heating element within the internal cavity so that food when positioned within the cooking vessel can also be heated over time, a temperature probe comprising a temperature sensor for reading a sensed temperature of a food product or liquid within the cooking vessel and for communicating the sensed temperature to the control module, and a control module operatively connected with the temperature probe, the control module provided to the cooking body and operatively connected with the heating element for controlling a heat setting of the heating element for cooking food according to one of a plurality of different cooking modes, the control module including a user interface allowing selection from the plural different cooking modes including at least a temperature probe mode, which temperature probe mode controls heating of the food product or liquid within the cooking vessel by the heating element to attain a user selected temperature, after which the temperature probe mode switches to a time mode during which a user can manually change the user selected temperature higher or lower.

Preferably, the slow cooker includes a lid for closing the cooking vessel that provides plural probe openings through the lid to allow the temperature probe to be inserted within food or liquid within the cooking vessel from plural different angles. The lid can also have a handle that is centrally located and one of the openings is provided through a portion of the handle to accommodate the temperature probe. The probe can have an extension element with the temperature sensor provided near a distal end thereof and the length of the extension element can be determined for positioning the temperature sensor near a bottom of the cooking vessel when the temperature probe is inserted through the opening through the handle portion.

The control module of the slow cooker preferably maintains the food product or liquid within the cooking vessel at the user selected temperature for a further time period after the user selected temperature is attained unless the cooking mode is stopped by a user or the user selected temperature is changed to a new temperature, in which case the new temperature is maintained. The control module preferably includes a microprocessor and memory with programming for controlling the plural cooking modes, wherein the temperature probe mode preferably also switches to a time mode after the user selected temperature is attained during which the user selected temperature of the food product will be maintained, the time mode including the starting of a timer provided within a display of the control module counting upward to provide an indication to the user of the time mode timing. The time mode can have a maximum time period, the expiration of which shuts off the slow cooker. Preferably also, during the time mode, a user can manually change the user selected temperature higher or lower.

The control module also preferably controls the temperature probe mode to include the ability for the user to provide a user selected time in addition to the user selected temperature, the user selected time applying to the time period over which the user selected temperature is maintained after the user selected temperature is attained.

Additionally, the control module preferably includes programming for controlling a sous vide mode and a slow cook mode in addition to the temperature probe mode. For the sous vide mode, the heating element is controlled to heat the cooking vessel so as to maintain a liquid within the cooking vessel at a user selected temperature based on sensed temperature feedback from the temperature probe to the control module and to maintain the user selected temperature for a user selected sous vide time period. At the start of the user selected sous vide period a timer provided within a display of the control module will preferably display the user selected sous vide period and begin counting down to provide an indication to the user of the sous vide period remaining Preferably also, the user selected sous vide time period can be modified at any time during the sous vide cooking mode.

These and various other features and advantages will be apparent from a reading of the following detailed description.

### BRIEF DESCRIPTION OF THE DRAWINGS

The present invention will be further explained with reference to the appended Figures, wherein like structure is referred to by like numerals throughout the several views, and wherein:

FIG. 1 is a partially exploded perspective view of a slow cooker appliance including a temperature probe that is usable with multiple cooking modes, according to various embodiments of the present invention;

FIG. 2 is a front view of the slow cooker of FIG. 1 with a control module mounted on a front surface of a cooker body, according to various embodiments;

FIG. 3 is a front view of the control module showing the various control buttons, display, and indicator lights that are associated with various cooking modes of the present invention;

FIG. 4 is an illustration of an algorithm for the control module that can be used when cooking with the temperature probe;

FIG. 5 is a chart showing the various factors and variables that are relied upon within the algorithm of FIG. 4; and

FIG. 6 is a table certain constants that are also relied upon within the algorithm of FIG. 4, which are based upon the cooking mode and temperatures selected by a user.

### DETAILED DESCRIPTION

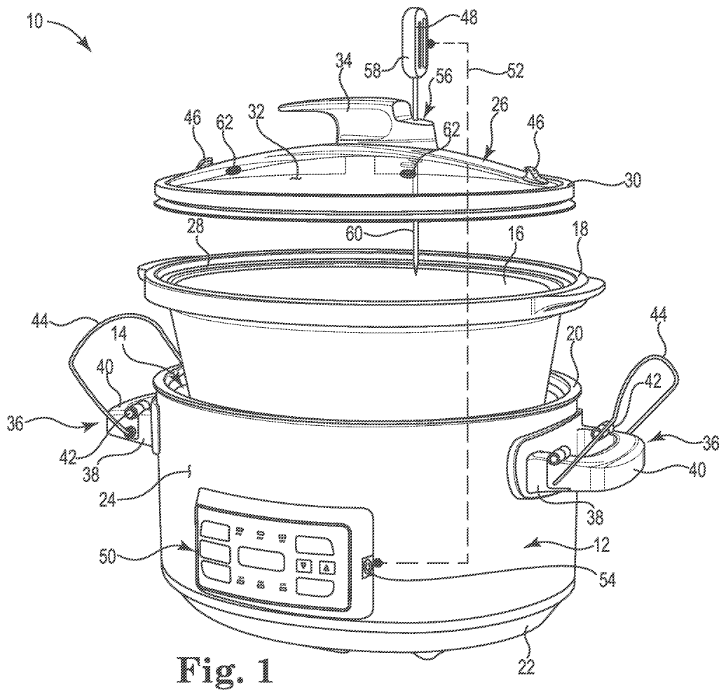

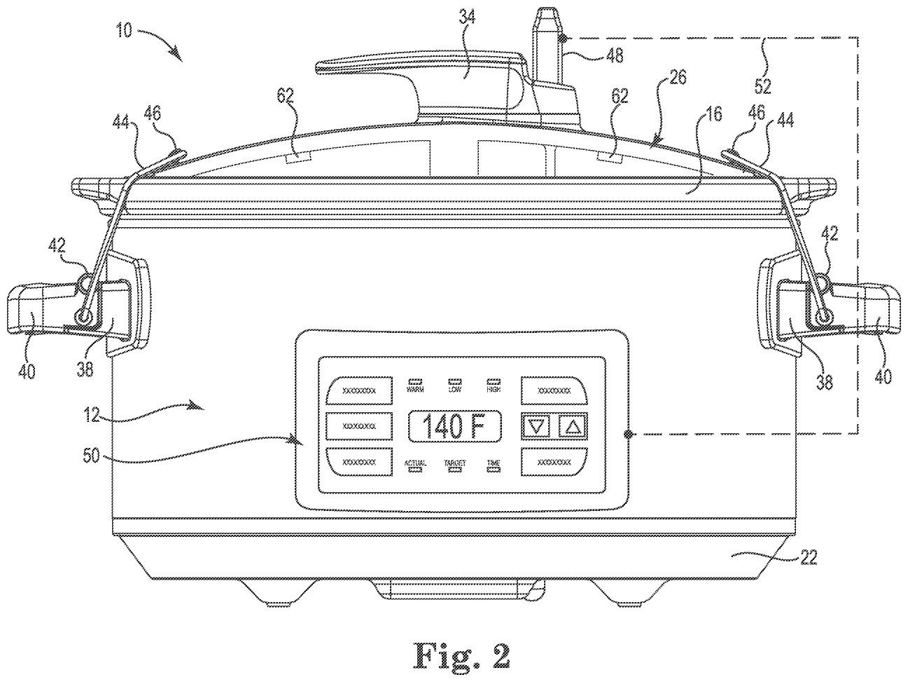

Disclosed is a slow cooker 10 as shown in FIGS. 1 and 2 having a cooker body 12 creating an internal cavity 14 within which a heating element (not shown) is provided for heating the internal cavity 14. A cooking vessel 16 is removably positioned within the internal cavity 14 as such can be conventionally supported relative to the heating element so that the cooking vessel 16 heats up to heat food as provided within the cooking vessel 16 for cooking. The cooking vessel 16 preferably includes a perimetric flange 18 that sits on top of an upper edge 20 of the cooker body 12 to position the cooking vessel 16 above the heating element. It is noted that like components are labeled with like numerals throughout the several figures.

The cooker body 12 can be conventionally constructed as having a base portion 22 and a sidewall portion 24 that creates the internal cavity 14. The sidewall portion 24 preferably comprises an outer shell as can be comprised of plastic, stainless steel, other metals, ceramic or the like that is designed for decorative and cleaning purposes. The sidewall portion 24 is also preferably insulated so that heat transferred to the cooking vessel 16 is not also transferred to the external surface of the sidewall portion 24. An inner surface of the sidewall portion 24 defines the size and shape of the internal cavity 14.

The slow cooker 10 also comprises a lid 26 that sits, in the illustrated embodiment, within a recess 28 of the cooking vessel 16 for closing the cooking vessel 16 during cooking. The lid 26 preferably is comprised of a frame 30 that is connected with a transparent cover 32 that can be arranged in any number of different designs. A transparent cover 32 can comprise glass, plastic, or the like so that food can be seen as it is being cooked. A handle 34 is also preferably provided as connected with the frame 30 for grasping of the lid 26.

The lid 26 is also preferably latched to the cooker body 12 so that the slow cooker 10 is portable without spilling of food as can be moved during cooking or afterwards such as for serving the cooked food at a different location from cooking. In the illustrated embodiment, cooker body handles 36 can be provided as secured to the cooker body 12 at opposed locations for providing such portability. Specifically, a fixed handle portion 38 can be secured to the cooker body 12 that is pivotally connected with a movable handle portion 40 by way of pivot axle 42. Each movable portion 40 also preferably includes a bail 44 that is pivotally connected with the movable portion 40 to loop over and grasp a hook portion 46 of the lid frame 30 when the movable portion 40 is pivoted upwards. The connection of the bail 44 with the movable portion 40 is arranged so that when the movable portion 40 is moved to a lower position (as in FIG. 2) the bail 44 is sufficiently springy to act as an over center spring latch mechanism for creating a bias and holding the lid 26 to the cooker body 12. Upward movement of the movable portion 40 releases the latch mechanism.

The lid 26 also preferably accommodates the use of a temperature probe 48. The temperature probe 48 can be operatively connected with a control module 50, such as shown on a front side of the cooker body 12 of the slow cooker 10. Electrical connection and/or data transmission connection can be provided by a communication link 52 as shown as a dashed line within FIGS. 1 and 2. Preferably the communication link 52 simply comprises an electrical cord that provides sensed temperature information from the temperature probe 48 to the control module 50 so that the temperature probe 48 and communication link 52 can act as a feedback circuit for the control module 50. With an electrical cord as the communication link 52, it is preferable that one or both ends of the cable comprise insertable plugs (not shown) that are received within a complimentary jack 54 as shown in FIG. 1. Alternatively, the communication link 52 can comprise a wireless connection, such as utilizing blue tooth technology or other known or developed wireless links. Various cooking modes can be supported by the provision of such actual sensed temperature information from the temperature probe 48 as will be discussed in greater detail below. Whatever communication link 52 is used, what is important is that the sensed temperature information, in whatever form, is provided to the control module 50.

In order to accommodate the temperature probe 48, the lid 26 can comprise any number of openings through the lid 26. Such a probe 48 may comprise a handle portion 58 fixed with an extension element 60 having a temperature sensor (not shown) near its tip as such temperature probes themselves are well known. One such opening 56 is shown provided through a portion of the lid handle 34. The opening 56 preferably is sized and shaped to accommodate passing of the extension element 60 without allowing significant passage of gases or liquids from the cooking vessel 16 during cooking. An elastic or flexible component (not shown), such as a rubber grommet or O-ring, can be provided for such purpose. By providing the opening 56 at the lid handle 34, a central location for the probe 48 to extend into the cooking vessel 16 is made. The probe 48 preferably has a length of its extension element 60 based upon the positioning of the temperature sensor within liquid or solid food during a cooking operation. For example, the tip of the probe extension element 60 having the temperature sensor could be designed to be positioned in close proximity to a bottom of the cooking vessel 16 or within a desired range of expected liquid or solid food within the cooking vessel 16.

Additional openings are also preferably provided such as shown at 62, an arrangement of such openings 62 preferably being such that the probe 48 can be inserted through the lid 26 for extending within liquid or solid food within the cooking vessel 16 at different locations and potentially different angles. Preferably, a pair of openings 62 are provided to each side of the lid handle 34 with each spaced radially similarly from the center of the lid 26. Such an arrangement allows the probe to be entered into a solid food or liquid from different angles and positioning of the food within the cooking vessel 16. Each opening 62 preferably also is sized and shaped to accommodate the extension element 60 of the probe 48 without allowing significant passage of gases or liquids from the cooking vessel during cooking. Also, an elastic or flexible component, such as a rubber grommet or O-ring, can be provided for such purpose and to allow the angle of the extension element 60 toward food within the cooking vessel 16 to be adjusted. The openings 62 can be otherwise provided in different arrangements including plural openings at differing radial spacing from the lid's center point.

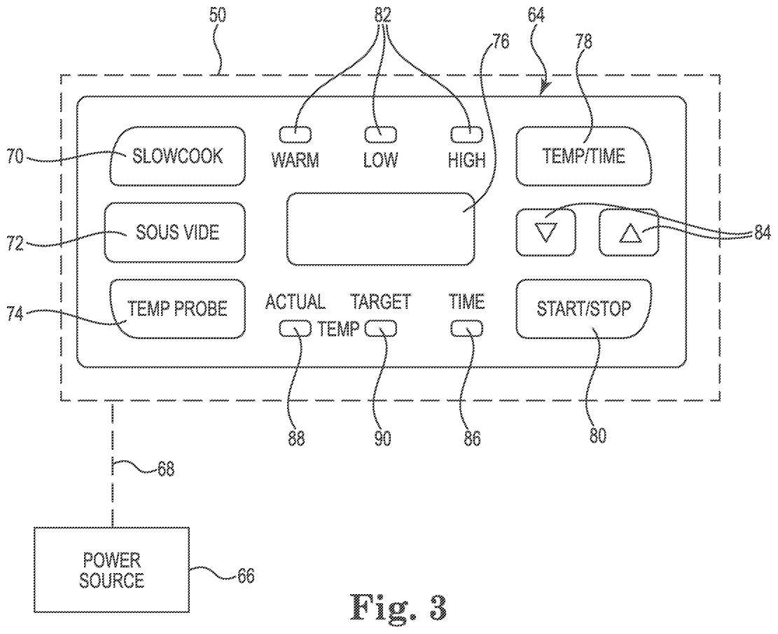

The control module 50 is preferably connected to the cooker body 12 at a front location of the slow cooker 10 as shown in FIGS. 1 and 2 for easy access of its control interface 64 by a user as schematically illustrated in FIG. 3. The control module 50 is illustrated as electrically connectible with an electric power source 66 by way of a conventional electrical connection at 68, which electrical connection could comprise a wiring harness designed for and routed within the slow cooker 10 leading to a plug for connection with line power. The control module 50 can include a microprocessor and memory as operatively connected together, the memory including programming that may comprise software or firmware for controlling any number of cooking modes, such as those described below.

The user interface 64 can set up any number of cooking modes, but preferably includes selection buttons 70, 72, and 74 for at least a slow cook mode, a sous vide mode, and a temperature probe mode, respectively, as shown in the preferred user interface 64 of FIG. 3. Details of each of these preferred cooking modes will be described below. It is noted that the user interface 64 can utilize any known or developed manner for user selection, such as including a touch screen, capacitive touch buttons, electrical or electro-mechanical buttons, or the like.

Preferably, the user interface 64 also includes a display screen 76 as can comprise an LED or other known or developed display technology. Additional control buttons can include a toggle button 78 for temperature or time selection, a start/stop button 80, heat selection indicators 82, up and down user selection buttons 84 for choosing time or temperature depending on the toggle button 78, a time indicator 86 that is lit when a time is displayed, and temperature indicators 88 and 90 that are lit when displaying actual and target temperatures, respectively.

As noted above, the slow cooker is preferably set up with operating parameters for at least a slow cooking mode, a sous vide mode, and a temperature probe mode. Each of these modes is user selectable based upon an initial selection of one of the selection buttons. 70, 72, and 74. The sous-vide mode and the temperature probe mode each utilize the temperature probe 48 to provide actual sensed temperature feed back to the control module 50. The slow cooking mode is a traditional slow cooker mode.

The temperature probe mode utilizes the temperature probe 48 as such temperature probe 48 can be inserted through one of the openings 56 or 62 and into a food product, such as a piece of meat. This allows the user to accurately gauge the internal temperature of the food product. Once the temperature is set by the user, the user can leave the slow cooker 10 and the slow cooker 10 will heat the food product to the desired temperature and hold it at that temperature until the user turns the slow cooker off. One advantage is that the user only needs to set the temperature and the process creates a tender finished food product with no overcooking or drying out of the food product.

More specifically, one preferred manner to operate the temperature probe mode is described as follows. Many variations to the preferred manner are contemplated. The user will initially connect the slow cooker 10 to power upon which a default display can be provided in the display screen 76, such as a series of flashing dashes. A food product or any mixture of food products are added to the cooking vessel 16 which may or may not be positioned within the slow cooker 10. If not, the cooking vessel 16 is then positioned within the slow cooker 10. After putting the lid 26 on the cooking vessel 16, the temperature probe is inserted into the food product by which cooking temperature is to be targeted, most likely a protein or meat product. The multiple locations of the holes 56 or 62 allow positioning from a number of locations and angles.

The user would then select the temperature probe button 74 and the indicator light 90 (such as an LED) below target temperature will light up. The user is thus notified that the slow cooker 10 is ready for setting of the desired cooking temperature of the food product. A default temperature such as 180 degrees F. can be displayed and user manipulation of the up and down arrows 84 can be used to manipulate the displayed target temperature in desired increments such as one degree F. increments. A preferred temperature range for selection by the user is between 100 degrees F. and 195 degrees F. The display preferably flashes the target temperature at this time until the user sets the target temperature by pressing the stop/start button 80. After that, the LED actual temperature indicator 88 will light up as the probe is now sensing the food product actual temperature, which temperature will be displayed now and throughout the cooking process. Also after the start/stop button 80 is pressed, a control program will be initiated and followed.

The control module 50 will continue to follow the control program or algorithm (discussed in greater detail below) until the temperature probe 48 senses that the food product has reached the desired target temperature. The display will display the actual temperature along the way with the actual temperature indicator LED 88 lit. Once the target temperature is sensed, the slow cooker will switch to a time mode during which the temperature of the food product will be maintained. The object of this mode is to keep the food product at the desired temperature for a period of time in order to create a tender finished food product without overcooking. Preferably, at the attainment of the target temperature, an audible alarm will let the user know the target temperature has been attained and the display will switch to a timing mode and will display a counter counting up from zero as a timer. The timer can then count upward until a maximum time period, such as 99:59. At any time during the timing mode, the user can select the start/stop button 80 to stop cooking or the slow cooker will turn off after reaching the maximum time period preferably along with an audible alarm as well. Audible alerts can be provided in any number of process steps.

Additionally, it is preferred that the target temperature can be changed after switching to the timing mode. The user can change the target temperature after the timer has started counting upward by selecting the temp/time button 78 once. The display will show the initial target temperature. The user would then be required to manually change the target temperature higher or lower by pressing the up and down arrows 80 to a new target temperature. The new target temperature may flash for a few seconds before resetting. Preferably also, the display will again show the timer counting up as from when the initial target temperature was reached without resetting the timer to zero (unless the cooking program is actually restarted).

It is also contemplated to add a user selected time aspect to the temperature probe mode. For example, after the target temperature is set as described above and prior to pressing the stop/start button 80, the user could select the temp/time button 78 to allow a time entry. Such a time entry could be a substitute for the default timer aspect for continued heating of the food product after the target temperature is attained. The user would instead at the initial cooking stage select both the target temperature and the time to maintain that target temperature to cook a food product at a desired temperature and time. A time would be selected similarly by the up and down arrow buttons 84 after which time selection is complete starting the cooking process as above by then pressing the stop/start button 80. The cooking process would proceed similarly but with a set time to maintain the target temperature. It is contemplated that the target temperature could then be manually revised during the time period as above. It is also contemplated that the set time could be also reset during the time period after target temperature is achieved, such as by pressing the temp/time button twice during the set time period. The display could change to show the set time period and could allow change by the arrows 84 similarly as above for the target temperature.

The sous-vide mode also utilizes the temperature probe 48 to provide sensed temperature feedback to the control module 50 in much the same way as the temperature probe mode. A preferred manner to operate the sous-vide mode is described as follows. As above, the user will initially connect the slow cooker 10 to power upon which a default display can be provided in the display screen 76, such as a series of flashing dashes. A food product as provided within a sealed bag or the like is added to the cooking vessel 16 which may or may not be positioned within the slow cooker 10. Water is added to the cooking vessel of sufficient quantity to immerse the sealed bag and food product. If not done earlier, the cooking vessel 16 can then positioned within the slow cooker 10. After putting the lid 26 on the cooking vessel 16, the probe 48 is preferably inserted through the hole 56 that is provided through a portion of the lid handle 34. The use, in particular, of the hole 56 as opposed to the lid holes 62 is that the lid handle 34 and the hole 56 are preferably designed so that the extension portion 60 and in particular the end portion thereof with a temperature sensor is positioned proximate to the bottom of the cooking vessel 16 so as to be immersed as well within the water surrounding the sealed bag and cooking product. The lid handle 34 and the hole 56 are preferably designed along with the length of the temperature probe 48 to position the temperature sensor proximate to the bottom of the cooking vessel 16 for measuring water temperature. The hole 56 can be designed to sufficiently frictionally hold the extension portion 60 to be adjustable by some degree to further accommodate desired positioning of the temperature sensor within the water level.

The user would then select the sous-vide button and the indicator LED 90 below target temperature will light up. The user is thus notified that the slow cooker 10 is ready for setting of the desired cooking temperature of the water and ultimately, the food product. A default temperature such as 135 degrees F. can be displayed and user manipulation of the up and down arrows 84 can be used to manipulate the displayed target temperature in desired increments such as one degree F. increments. A preferred temperature range for selection by the user is between 100 degrees F. and 195 degrees F. The display preferably flashes the target temperature at this time until the user sets the target temperature by pressing the time/temp button 78. After pressing the time/temp button 78, a desired immersion cooking time would be selected similarly by the up and down arrow buttons 84. For sous-vide cooking, a minimum time can be based on known immersion cooking times for different food products to a desired doneness. Continued cooking beyond the minimal time does not change the food product doneness as the temperature is maintained at the desired doneness temperature. The time can be set by changing the time one minute at a time, which function can switch to a larger interval, such as 10 minute increments after so many one minute increments. A maximum time is preferably defined, such as twenty hours. Once the time selection is complete the cooking process can be started by then pressing the stop/start button 80.

After that, the LED actual temperature indicator 88 will light up as the probe is now sensing the water actual temperature, which temperature will be displayed now and until the selected water temperature is reached. When the water temperature reaches the set temperature, slow cooker 10 will preferably provide an audible alert and the set time will start counting down. Also after the start/stop button 80 is pressed, a control program will be initiated and followed.

The control module 50 will continue to follow the control program or algorithm (discussed in greater detail below) until the temperature probe 48 senses that the water temperature has reached the desired target temperature. The display will display the actual temperature along the way with the actual temperature indicator LED 88 lit. Once the target temperature is sensed, the slow cooker will switch to a time mode during which the temperature of the water will be maintained. The object of this mode is to keep the food product at the desired temperature for a period of time in order to create a tender finished food product without overcooking.

The target temperature can also preferably be changed during the heating up of the water to the target temperature or after switching to the timing mode. The user can change the target temperature by selecting the temp/time button 78 once. The display will show the initial target temperature. The user would then be required to manually change the target temperature higher or lower by pressing the up and down arrows 80 to a new target temperature. The new target temperature may flash for a few seconds before resetting. Preferably also, the display will again show actual temperature or the timer counting down.

If the user presses the temp/time button 78 twice, the set cooking time can also be modified at any time. The set time could be added to or subtracted from by the up and down arrow buttons 84, after which the new cooking time will be set. Audible alerts can be incorporated throughout.

A traditional slow cook mode does not utilize the temperature probe 48 but instead requires user input of both a predefined heat level for cooking and a cook time. Specifically, once the slow cooker is powered up, a user would select one of three predefined cooking temperatures, warm, low, and high by pressing the slowcook button 70 one, two, or three times, respectively. Preferably, the warm temperature is predefined at 140 degrees F., the low temperature is predefined at 175 degrees F., and the high temperature is predefined at 190 degrees F. Other predefined temperatures and/or other variations more than warm, low, and high are also contemplated. The LED indicator lights 82 will show which predefined temperature has been selected.

After a cooking temperature has been selected, a default time will display within the display 76. For the low setting, a default temperature can be chosen that is a fairly long time period like 8 hours as such is a typical expected cook time at that temperature. The user can adjust the time period from the default by manipulating the up and down arrows in the same manner as described above in the other cooking modes. For the high setting a preferred default time is 4 hours. A preferred maximum time for either the low or high selection is 20 hours. After the temperature and time are user selected, the user presses the start/stop button 80 to begin the cooking process and the temperature control with regulate at the predefined temperature. During the cooking cycle, whether low or high, the time indicator 86 will be lit and the display will show the remaining cook time.

After the cooking cycle based on the user selected temperature and time is complete, the slow cooker 10 is switched to a warm mode by the control module 50. The indicator lights 82 will change accordingly as well to show that the unit is in the warm mode. After either of the low or high cooking process is done and the slow cooker 10 is switched to the warm mode, the display can show a counter, preferably counting upward from zero to 4 hours. The slow cooker 10 can be shut off by a user at any time by selecting the start/stop button 80, or the control module 50 will turn the slow cooker 10 off after the counter reaches the predetermined maximum warm time. Preferably, cook time can be changed during the cooking cycle. Since temperature is predefined, the user can simply use the up and down arrows 84 at any time to change the set time by adding or subtracting from the time remaining.

A warm cycle is initiated by a single press of the slowcook button 70 lighting the warm indicator 82. The display 76 will preferably show a default time setting of zero. Then upon a user selecting the start/stop button 80, the control module 50 will regulate the temperature of the slow cooker 10 to the predefined warm temperature and the display will begin counting upward toward a maximum keep warm time period, such as 4 hours. Audible alerts can be incorporated throughout.

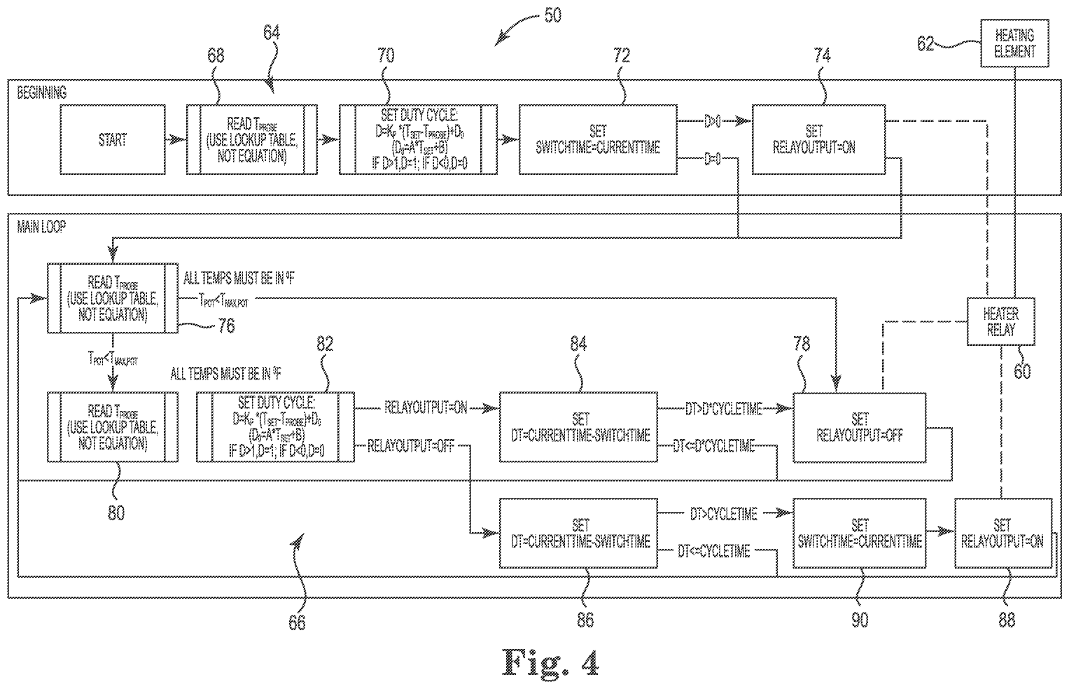

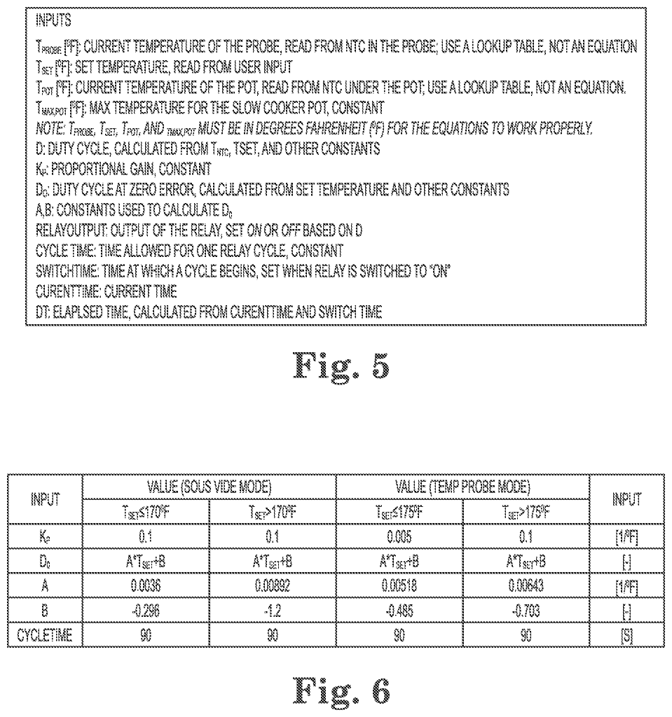

With reference to FIGS. 4, 5, and 6, a preferred program or algorithm for the control module 50 is illustrated that is used when cooking with the temperature probe 48, such as for either of the temperature probe mode or the sous vide mode. The purpose of the algorithm is to controllably bring either the food product directly or the water to indirectly heat the food product up to temperature over a time period. The basic function is to turn on and off a heater relay 60 as shown schematically electronically connected with the control module 50 running the heater control algorithm and connected with a heater element 62. The algorithm comprises an initiation portion 64 leading up to a repeated main loop 66. FIGS. 5 and 6 illustrate the factors and variables as are relied upon within the control algorithm of FIG. 4. A number of constants are also set out within the table of FIG. 6 which are selected based upon the cooking mode selected by the user and on the set temperatures also selected by the user.

The initiation portion 64 sets up the main loop 64 once the start/stop button 80 is pressed to start either the temperature probe mode or the sous-side mode. At step 68, the temperature output of the temperature probe 48 is read and obtained by the control module 50. In step 70, a duty cycle value is determined based primarily on the difference between the user set temperature and the sensed temperature at the probe. Step 72 sets a switch time (time when a cycle begins based on the heater relay being switched on) to be current time. If then the duty cycle value is greater than zero the heater relay 60 is turned on and the switch time cycle begins. From there, the main loop 66 controls the incremental changes to the heating element 62 by turning off and on the heater relay 60.

The main loop 66 starts at step 76 by reading a temperature of the slow cooker 10 at the bottom of the cooker body 12 below the cooking vessel 16, such as by way of a conventional NTC sensor. If the sensed temperature of the cooker is greater than a predetermined maximum temperature (determined to keep the cooker from overheating), then the heater relay is switched off at step 78. That would restart the main loop 66 and the heating element 62 would not be turned on until the cooker temperature was below the maximum.

If below the maximum cooker temperature, another duty cycle would be determined for incremental continued heating of the heating element 62. At step 80, the temperature probe temperature is read and in step 82 a new duty cycle is determined in a similar manner as in the initiation portion 64. If the relay output is on at that time, step 84 follows; if not, step 86 follows. In either case a comparison is made of the elapsed time of the current cycle to determine whether the heater relay 60 is to be switched off as at step 78 or on as in step 88 following a cycle clock reset step at 90. At the end of each decision step made at step 78 or step 88 the algorithm returns to the beginning of the main loop. By such a control algorithm, the heating element 62 is selectively modulated to obtain the user selected cooking temperature (either of the food product or the immersion water) within the slow cooker 10 and to thereafter maintain the set temperature based on actual temperature sensed data from the probe 48.

The present invention has now been described with reference to several embodiments thereof. The foregoing detailed description and examples have been given for clarity of understanding only. No unnecessary limitations are to be understood therefrom. It will be apparent to those skilled in the art that many changes can be made in the embodiments described without departing from the scope of the invention. The implementations described above and other implementations are within the scope of the following claims.

What is claimed is:

1. A slow cooker for heating food over time comprising:
a cooking body defining an internal cavity within which a heating element is provided for heating the internal cavity;
a cooking vessel removably received within the internal cavity of the heating body, the cooking vessel being heated by the heating element within the internal cavity so that food when positioned within the cooking vessel can also be heated over time;
a temperature probe comprising a temperature sensor for reading a sensed temperature of a food product or liquid within the cooking vessel and for communicating the sensed temperature to the control module; and
a control module operatively connected with the temperature probe, the control module provided to the cooking body and operatively connected with the heating element for controlling a heat setting of the heating element for cooking food according to one of a plurality of different cooking modes, the control module including a user interface allowing selection from the plural different cooking modes including at least a temperature probe mode, which temperature probe mode controls heating of the food product or liquid within the cooking vessel by the heating element to attain a user selected temperature and to maintain the food product or liquid within the cooking vessel at the user selected temperature for a further time period unless the cooking mode is stopped by a user.

2. The slow cooker of claim 1, further comprising a lid for closing the cooking vessel, the lid providing plural probe openings through the lid to allow the temperature probe to be inserted within food or liquid within the cooking vessel from plural different angles.

3. The slow cooker of claim 2, wherein the lid comprises a handle the is centrally located and one of the openings is provided through a portion of the handle, the temperature probe having an extension element with the temperature sensor provided near a distal end thereof and the length of the extension element being provided for positioning the temperature sensor near a bottom of the cooking vessel when the temperature probe is inserted through the opening through the handle portion.

4. The slow cooker of claim 1, wherein the control module comprises a microprocessor and memory with programming for controlling the plural cooking modes, and the temperature probe mode switches to a time mode after the user selected temperature is attained during which the user selected temperature of the food product will be maintained, the time mode including the starting of a timer provided within a display of the control module counting upward to provide an indication to the user of the time mode timing.

5. The slow cooker of claim 4, wherein the time mode has a maximum time period, the expiration of which shuts off the slow cooker.

6. The slow cooker of claim 4, wherein during the time mode, a user can manually change the user selected temperature higher or lower.

7. The slow cooker of claim 1, wherein the control module comprises a microprocessor and memory with programming for controlling the plural cooking modes, and the temperature probe mode includes the ability for the user to provide a user selected time in addition to the user selected temperature, the user selected time applying to the time period over which the user selected temperature is maintained after the user selected temperature is attained.

8. The slow cooker of claim 1, wherein the control module comprises a microprocessor and memory with programming for controlling the plural cooking modes, including a sous vide mode and a slow cook mode in addition to the temperature probe mode.

9. The slow cooker of claim 8, wherein during the sous vide mode, the heating element is controlled to heat the cooking vessel so as to maintain a liquid within the cooking vessel at a user selected temperature based on sensed temperature feedback from the temperature probe to the control module and to maintain the user selected temperature for a user selected sous vide time period.

10. The slow cooker of claim 9, wherein at the start of the user selected sous vide period a timer provided within a display of the control module will display the user selected sous vide period and begin counting down to provide an indication to the user of the sous vide period remaining.

11. The slow cooker of claim 10, wherein the user selected sous vide time period can be modified at any time during the sous vide cooking mode.

12. A slow cooker for heating food over time comprising:
a cooking body defining an internal cavity within which a heating element is provided for heating the internal cavity;
a cooking vessel removably received within the internal cavity of the heating body, the cooking vessel being heated by the heating element within the internal cavity so that food when positioned within the cooking vessel can also be heated over time;
a temperature probe comprising a temperature sensor for reading a sensed temperature of a food product or liquid within the cooking vessel and for communicating the sensed temperature to the control module; and
a control module operatively connected with the temperature probe, the control module provided to the cooking body and operatively connected with the heating element for controlling a heat setting of the heating element for cooking food according to one of a plurality of different cooking modes, the control module including a user interface allowing selection from the plural different cooking modes including at least a temperature probe mode, which temperature probe mode controls heating of the food product or liquid within the cooking vessel by the heating element to attain a user selected temperature, after which the temperature probe mode switches to a time mode during which a user can manually change the user selected temperature higher or lower.

13. The slow cooker of claim 12, wherein during the time mode the control module maintains the food product or liquid within the cooking vessel at the user selected temperature for a further time period unless the cooking mode is stopped by a user or the user selected temperature is changed to a new temperature, in which case the new temperature is maintained.

14. The slow cooker of claim 12, wherein the control module comprises a microprocessor and memory with programming for controlling the plural cooking modes, and the temperature probe mode switches to a time mode after the user selected temperature is attained during which the user selected temperature of the food product will be maintained, the time mode including the starting of a timer provided within a display of the control module counting upward to provide an indication to the user of the time mode timing.

15. The slow cooker of claim 14, wherein the time mode has a maximum time period, the expiration of which shuts off the slow cooker.

16. The slow cooker of claim 14, wherein during the time mode, a user can manually change the user selected temperature higher or lower.

17. The slow cooker of claim 12, wherein the control module comprises a microprocessor and memory with programming for controlling the plural cooking modes, and the temperature probe mode includes the ability for the user to provide a user selected time in addition to the user selected temperature, the user selected time applying to the time period over which the user selected temperature is maintained after the user selected temperature is attained.

18. The slow cooker of claim 12, wherein the control module comprises a microprocessor and memory with programming for controlling the plural cooking modes, including a sous vide mode and a slow cook mode in addition to the temperature probe mode.

19. The slow cooker of claim 18, wherein during the sous vide mode, the heating element is controlled to heat the cooking vessel so as to maintain a liquid within the cooking vessel at a user selected temperature based on sensed temperature feedback from the temperature probe to the control module and to maintain the user selected temperature for a user selected sous vide time period.

20. The slow cooker of claim 19, wherein at the start of the user selected sous vide period a timer provided within a display of the control module will display the user selected sous vide period and begin counting down to provide an indication to the user of the sous vide period remaining, and the user selected sous vide time period can be modified at any time during the sous vide cooking mode.
